(19) United States
(12) Patent Application Publication
(10) Pub. No.: US 2024/0248112 A1
(43) Pub. Date: Jul. 25, 2024

(54) WHEEL SPEED SENSING DEVICE

(71) Applicant: HL MANDO CORPORATION, Gyeonggi-do (KR)

(72) Inventors: Jong Sik SONG, Gyeonggi-do (KR); Yong Kyun JUNG, Gyeonggi-do (KR)

(21) Appl. No.: 18/575,776

(22) PCT Filed: Jun. 29, 2022
(86) PCT No.: PCT/KR2022/009304

§ 371 Date: Dec. 29, 2023

(30) Foreign Application Priority Data
Jun. 30, 2021 (KR) 10-2021-0085681

(51) Int. Cl. G01P 1/02

(52) U.S. Cl. CPC G01P 1/026

(57) ABSTRACT

A wheel speed sensing device is disclosed. The wheel speed sensing device according to an embodiment of the present disclosure includes a first sensor module including a first housing including a first sensor housing and a first cable housing connected to a rear end of the first sensor housing, a first wheel speed sensor disposed inside the first sensor housing, and a first cable connected to a rear end of the first wheel speed sensor to transmit a detecting signal of the first wheel speed sensor to an electronic controller, while a predetermined front section thereof is disposed inside the first cable housing; a second sensor module including a second housing including a second sensor housing and a second cable housing connected to a rear end of the second sensor housing, a second wheel speed sensor disposed inside the second sensor housing, and a second cable connected to a rear end of the second wheel speed sensor to transmit a detecting signal of the second wheel speed sensor to an electronic controller, while a predetermined front section thereof is disposed inside the second cable housing; and a housing holder connecting the first housing and the second housing so that the first sensor module and the second sensor module are aligned and arranged side by side; wherein the housing holder includes a retaining portion for surrounding and retaining an outer surface of the first housing and the second housing, and an extending portion for protruding and extending upward from the retaining portion such that the retaining member for retaining the housing holder onto a chassis is coupled thereto.

### CROSS-REFERENCE TO RELATED APPLICATION

This application claims priority to and the benefit of Korean Patent Application No. 10-2021-0085681, filed on Jun. 30, 2021, the disclosures of which is incorporated herein by reference in its entirety.

### FIELD

The present disclosure relates to a wheel speed sensing device, and more particularly, to a wheel speed sensing device including a wheel speed sensor for detecting a rotation speed of a wheel of a vehicle.

### BACKGROUND

Various devices are installed in the vehicle to improve driving and braking stability. For example, ABS (Anti-Lock Brake System) and TCS (Traction Control System) for preventing wheel slip, ESP (Electronic Stability Program) for vehicle posture control, CDC (Continuous Damping Control) for suspension, and EPS (Electric Power Steering) for steering assistance are mounted.

These devices receive signals from various sensors such as a yaw rate sensor, a steering angle sensor, a wheel speed sensor, a brake pressure sensor, and a lateral acceleration sensor for control. Among them, the wheel speed sensor is a key sensor that transmits the wheel speed signal of the vehicle, and most ECUs (Electronic Controller) utilize the detecting information of the wheel speed sensor. The operation of ABS, TCS, and the like may be determined through the signal measured by the wheel speed sensor.

Conventionally, it is common to arrange one wheel speed sensor for each wheel of a vehicle. However, there is an increasing need to place two wheel speed sensors for each wheel of the vehicle to improve detection accuracy, reliability, or secure redundancy. Accordingly, there is a need for a development of a sensor mounting technology that provides assembly and space efficiency while stably aligning two wheel speed sensors so that the two wheel speed sensors operate stably.

### SUMMARY

The present disclosure is to solve the problems of the prior art, and the object of the present disclosure is to provide a wheel speed sensing device having assemblability and space efficiency while two wheel speed sensors can be stably arranged and placed.

According to an aspect of the present disclosure, there is provided a wheel speed sensing device including a first sensor module including a first housing including a first sensor housing and a first cable housing connected to a rear end of the first sensor housing, a first wheel speed sensor disposed inside the first sensor housing, and a first cable connected to a rear end of the first wheel speed sensor to transmit a detecting signal of the first wheel speed sensor to an electronic controller, while a predetermined front section thereof is disposed inside the first cable housing; a second sensor module including a second housing including a second sensor housing and a second cable housing connected to a rear end of the second sensor housing, a second wheel speed sensor disposed inside the second sensor housing, and a second cable connected to a rear end of the second wheel speed sensor to transmit a detecting signal of the second wheel speed sensor to an electronic controller, while a predetermined front section thereof is disposed inside the second cable housing; and a housing holder connecting the first housing and the second housing so that the first sensor module and the second sensor module are aligned and arranged side by side; the housing holder may include a retaining portion for surrounding and retaining an outer surface of the first housing and the second housing, and an extending portion for protruding and extending upward from the retaining portion such that the retaining member for retaining the housing holder onto a chassis is coupled thereto.

In this case, the retaining portion may include a sensor housing retaining portion disposed to surround rear portions of the first sensor housing and the second sensor housing, and a cable housing retaining portion disposed to surround the first cable housing and the second cable housing.

In addition, the housing holder may further include a first rib for protruding from an outer surface of the sensor housing retaining portion to be crushed and provide fixing force when assembled to the chassis.

In addition, the first cable housing may include a first cylindrical body disposed to surround an outer circumferential surface of the first cable, and a first flange protruding and extending radially outward from an outer circumferential surface of the first cylindrical body; and the second cable housing may include a second cylindrical body disposed to surround an outer circumferential surface of the second cable, and a second flange protruding and extending radially outward from an outer circumferential surface of the second cylindrical body.

In addition, the retaining portion may include a first retaining member disposed to surround rear lower portions of the first housing and the second housing, and a second retaining member disposed to surround rear upper portions of the first housing and the second housing and fastened to the first retaining member.

In addition, the extending portion may protrude and extend from an upper portion of the second retaining member.

In addition, the first retaining member may include a lower sensor housing retaining portion disposed to surround rear lower portions of the first sensor housing and the second sensor housing, and a lower cable housing retaining portion disposed to surround lower portions of the first cable housing and the second cable housing; and the second retaining member may include an upper sensor housing retaining portion disposed to surround rear upper portions of the first sensor housing and the second sensor housing, and an upper cable housing retaining portion disposed to surround the upper portions of the first cable housing and the second cable housing.

In addition, the first housing and the second housing may include first fixing protrusions for protruding in a vertical direction on at least one of the upper and lower surfaces, and the housing holder may further include first fixing through holes vertically penetrated through at least one of the lower sensor housing retaining portion and the upper sensor housing retaining portion, so that the first fixing protrusions are inserted thereinto.

In addition, the first fixing protrusions may include a protrusion body for protruding from upper surface or lower surface of the first sensor housing or the second sensor housing at a predetermined height, and a hook additionally for protruding by being extended in the front and rear directions from an extended end of the protrusion body.

In addition, the housing holder may further include an elastic guide for protruding inwardly from the first fixing through hole to a front and rear of the first fixing through holes, and elastically deformed upward by the hook when the first fixing protrusions enter, and restored after the first fixing protrusions enter, and disposed so that a lower surface of the hook is caught.

In addition, the first retaining member may include a fastening protrusion or a fastening groove at one side and the other side, and the second retaining member may include a fastening groove or a fastening protrusion corresponding to the fastening protrusion or the fastening groove at one side and the other side.

In addition, the housing holder may further include a connecting member having one side connected to one side of the first retaining member and the other side connected to one side of the second retaining member to connect the first retaining member and the second retaining member.

In addition, the retaining portion may include a sensor housing retaining portion formed such that the first sensor module and the second sensor module are inserted from a rear to a front and arranged side by side, and disposed to surround the rear portions of the first sensor housing and the second sensor housing, and a cable housing retaining portion disposed to surround the first cable housing and the second cable housing.

In addition, the first sensor housing and the second sensor housing may include second fixing protrusions for protruding in the vertical direction on at least one of an upper and lower surfaces, and the housing holder may further include a snap clip formed side by side on at least one of an upper surface and lower surfaces of the sensor housing retaining portion such that the second retaining protrusions are snap-fitted when the first sensor module and the second sensor module are inserted.

In addition, the first cable housing may include a first cylindrical body disposed to surround an outer circumferential surface of the first cable, and a first flange for protruding and extending radially outward from an outer circumferential surface of the first cylindrical body; and the second cable housing may include a second cylindrical body disposed to surround an outer circumferential surface of the second cable, and a second flange for protruding and extending radially outward from an outer circumferential surface of the second cylindrical body; the first flange and the second flange may be inserted and seated in the cable housing retaining portion.

In addition, the first cable housing and the second cable housing may include a second rib for protruding from an outer circumferential surfaces of the first flange and the second flange to be crushed and provide fixing forces when inserted into the cable housing retaining portion.

According to an embodiment of the present disclosure, the first wheel speed sensor and the second wheel speed sensor are arranged side by side by the housing holder in a state of being arranged in the first housing and the second housing, respectively, so that two wheel speed sensors can be stably arranged and the assembly and space efficiency can be secured.

### BRIEF DESCRIPTION OF THE DRAWINGS

FIG. 1 shows a block diagram of a system to which a wheel speed sensing device according to embodiments of the present disclosure may be applied.

FIG. 2 shows a perspective view of a first sensor module and a second sensor module of a wheel speed sensing device according to a first embodiment of the present disclosure.

FIG. 3 shows a perspective view of a wheel speed sensing device according to the first embodiment of the present disclosure.

FIG. 4 shows a perspective view of a wheel speed sensing device according to a second embodiment of the present disclosure.

FIG. 5 shows a side view of the sensor module of the wheel speed sensing device according to the second embodiment of the present disclosure.

FIG. 6 shows a perspective view of a housing holder of a wheel speed sensing device according to the second embodiment of the present disclosure.

FIG. 7 shows a rear view of the housing holder of the wheel speed sensing device according to the second embodiment of the present disclosure.

FIG. 8 shows a diagram showing an unassembled state of the wheel speed sensing device according to the second embodiment of the present disclosure.

FIG. 9 shows a perspective view of a wheel speed sensing device according to a third embodiment of the present disclosure.

FIG. 10 shows a perspective view of a sensor module of a wheel speed sensing device according to a third embodiment of the present disclosure.

FIG. 11 shows a perspective view of a housing holder of a wheel speed sensing device according to a third embodiment of the present disclosure.

FIG. 12 shows a rear view of the housing holder of the wheel speed sensing device according to the third embodiment of the present disclosure.

FIG. 13 shows a partial cutaway perspective view of the wheel speed sensing device according to the third embodiment of the present disclosure.

### DETAILED DESCRIPTION

Hereinafter, embodiments of the present disclosure will be described in detail with reference to the accompanying drawings so that those skilled in the art can easily implement them. The present disclosure may be implemented in many different forms and is not limited to the embodiments described herein. In order to clearly explain the present disclosure, parts not related to the description are omitted in the drawings, and the same or similar components are referred to throughout the specification by the same reference numerals.

In this specification, the terms “include” or “have” and the like are intended to describe the presence of features, numbers, steps, operations, components, parts or combinations thereof described in the specification, and should not be construed as excluding the presence or addition of one or more other features, numbers, steps, operations, components, parts or combinations thereof.

In this specification, “front”, “rear”, “upper”, or “lower”, etc., which are spatially relative terms to describe the correlation with the components shown in the drawings, may be used. These are relative terms determined based on the ones shown in the drawings, and the positional relationship may be interpreted as opposite depending on the orientation. In addition, the fact that a component is “connected” to another component includes not only direct connection to each other but also indirect connection to each other unless otherwise specified.

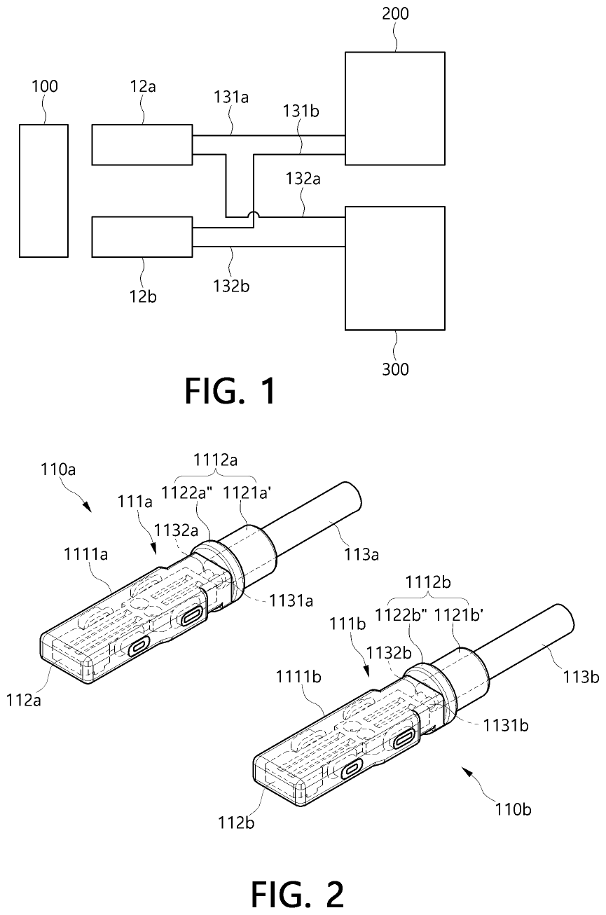

FIG. 1 shows a block diagram of an in-vehicle system to which a wheel speed sensing device according to embodiments of the present disclosure may be applied.

A system shown in FIG. 1 is for detecting a speed of a wheel of a vehicle. The system includes a tone wheel or encoder 100 coupled to the wheel of the vehicle and rotating together when the wheel rotates, and a first wheel speed sensor 12a and a second wheel speed sensor 12b installed side by side and spaced apart from the tone wheel or encoder 100 by a predetermined distance.

At this time, the first wheel speed sensor 12a and the second wheel speed sensor 12b operate simultaneously to improve accuracy and reliability of detection and may perform sensing. Meanwhile, the first wheel speed sensor 12a may operate first, and the second wheel speed sensor 12b may operate when the first wheel speed sensor 12a fails. That is, the second wheel speed sensor 12b may be arranged to secure redundancy.

The first wheel speed sensor 12a and the second wheel speed sensor 12b transmit their own sensing information to an electronic controller 200 through the first signal cable 131a and the second signal cable 131b, respectively. The first wheel speed sensor 12a and the second wheel speed sensor 12b may receive power from a battery 300 through the first power cable 132a and the second power cable 132b, respectively.

FIG. 2 shows a perspective view of a first sensor module and a second sensor module of a wheel speed sensing device according to a first embodiment of the present disclosure.

Referring to FIG. 2, the first sensor module 110a may include a first housing 111a, a first wheel speed sensor 112a, and a first cable 113a. The first housing 111a includes a first sensor housing 1111a and a first cable housing 1112a connected to the rear end of the first sensor housing 111a. The first wheel speed sensor 112a is disposed inside the first sensor housing 1111a, and the first cable 113a is connected to the rear end of the first wheel speed sensor 112a to transmit the detecting signal of the first wheel speed sensor 112a to the electronic controller 200, while a predetermined front section is disposed inside the first cable housing 1112a.

In this case, the first cable 113a may include a first signal cable 1131a for transmitting a signal and a first power cable 1132a for supplying power.

The second sensor module 110b may be configured in the same manner as the first sensor module 110a. That is, the second sensor module 110b may include a second housing 111b, a second wheel speed sensor 112b, and a second cable 113b.

The second housing 111b includes the second sensor housing 1111b and a second cable housing 1112b connected to the rear end of the second sensor housing 1111b. The second wheel speed sensor 112b is disposed inside the second sensor housing 1111b, and the second cable 113b is connected to the rear end of the second wheel speed sensor 112b to transmit the detecting signal of the second wheel speed sensor 112b to the electronic controller 200, while a predetermined front section is disposed inside the second cable housing 1112b.

In this case, the second cable 113b may include a second signal cable 1131b for transmitting a signal and a second power cable 1132b for supplying power.

If the first sensor module 110a and the second sensor module 110b are respectively fixed to a chassis to align and arrange the first wheel speed sensor 112a and the second wheel speed sensor 112b side by side, a fixing member (e.g., a bolt) for fixing to the chassis (e.g., a knuckle of the vehicle) must be coupled to the first housing 111a and the second housing 111b, respectively.

To this end, each of the first housing 111a and the second housing 111b must be provided with a configuration for coupling the fixing member. Accordingly, assemblability may be deteriorated, and space efficiency may be difficult to secure. However, the first embodiment of the present disclosure solves this problem through a housing holder 120.

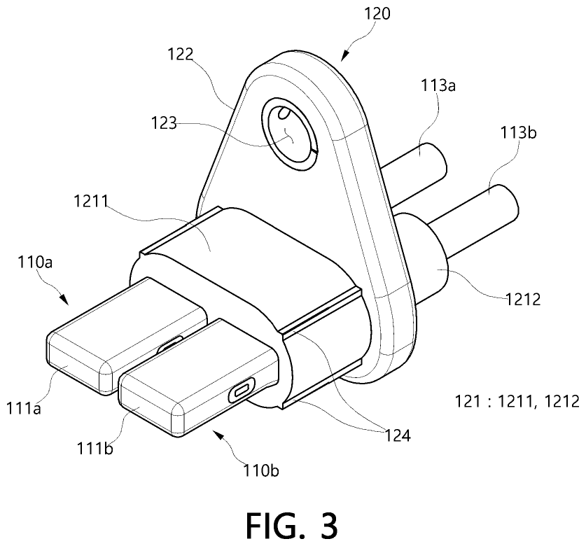

FIG. 3 shows a perspective view of a wheel speed sensing device according to the first embodiment of the present disclosure.

Referring to FIG. 3, the wheel speed sensing device according to the first embodiment of the present disclosure includes the first sensor module 110a, the second sensor module 110b, and the housing holder 120. The housing holder 120 connects the first housing 111a and the second housing 111b so that the first sensor module 110a and the second sensor module 110b are aligned and arranged side by side.

More specifically, the housing holder 120 may include a retaining portion 121 for surrounding and retaining the outer surface of the first housing 111a and the second housing 111b, and an extending portion 122 for protruding and extending upward from the retaining portion 121 such that the retaining member (not shown) for retaining the housing holder onto the chassis is coupled thereto. Meanwhile, the extending portion 122 may be provided with a through hole 123 through which the retaining member is disposed.

In the first embodiment of the present disclosure, the housing holder 120 may be formed by injection molding on the outside of the first sensor module 110a and the second sensor module 110b. In more detail, the housing holder 120 may be formed through insert injection.

In addition, the retaining portion 121 may include a sensor housing retaining portion 1211 disposed to surround the rear portions of the first sensor housing 1111a and the second sensor housing 1111b, and a cable housing retaining portion 1212 disposed to surround the first cable housing 1112a and the second cable housing 1112b.

As shown in FIG. 2, the first cable housing 1112a may include a first cylindrical body 1112a′ disposed to surround an outer circumferential surface of the first cable 113a, and a first flange 1112a″ protruding and extending radially outward from the outer circumferential surface of the first cylindrical body 1112a′. In addition, the second cable housing 1112b may include a second cylindrical body 1112b′ disposed to surround an outer circumferential surface of the second cable 113b, and a second flange 1112b″ protruding and extending radially outward from the outer circumferential surface of the second cylindrical body 1112b′.

In this way, when the first cable housing 1112a and the second cable housing 1112b are provided with the first flange 1122a″ and the second flange 1122b″ respectively, the cable housing retraining portion 1212 of the housing holder 120 is disposed to surround the first flange 1122a″ and the second flange 1122b″, thereby effectively preventing the first housing 111a and the second housing 111b from being separated from the housing holder 20.

Meanwhile, in the first embodiment of the present disclosure, the housing holder 120 further includes a first rib 124 for protruding from the outer surface of the sensor housing retaining portion 1211 to be crushed and provide fixing force when the wheel speed sensing device according to the first embodiment of the present disclosure is assembled to the chassis.

The first rib 124 may extend in the front and rear directions, and may be formed in plural numbers spaced apart from each other on the outer surface of the sensor housing retaining portion 1211. When assembled to the chassis, the sensor housing retaining portion 1211 of the housing holder 120 may be press-fitted into a groove disposed in the chassis side, and the first rib 124 is crushed inside the groove to increase friction. Accordingly, the sensor housing fixing part 1211 is prevented from being separated from the groove.

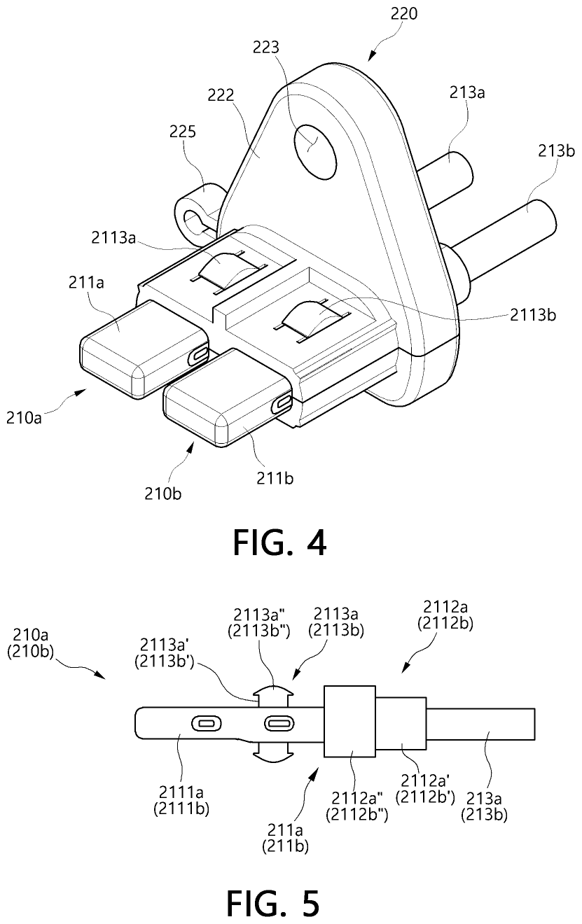

FIG. 4 shows a perspective view of a wheel speed sensing device according to a second embodiment of the present disclosure.

Referring to FIG. 4, the wheel speed sensing device according to the second embodiment of the present disclosure includes a first sensor module 210a, a second sensor module 210b, and a housing holder 220. In the second embodiment of the present disclosure, the housing holder 220 is configured in a clip type to connect a first housing 211a of the first sensor module 210a and a second housing 211b of the second sensor module 210b.

FIG. 5 shows a side view of the sensor module of the wheel speed sensing device according to the second embodiment of the present disclosure.

Referring to FIG. 5, in the second embodiment of the present disclosure, the first sensor module 210a includes a first housing 211a having a first wheel speed sensor disposed therein, and a first cable 213a connected to a rear end of the first wheel speed sensor and having a predetermined front section disposed in the first housing 211a. The second sensor module 210b also includes a second housing 211b having a second wheel speed sensor disposed therein and a second cable 213b connected to a rear end of the second wheel speed sensor and having a predetermined front section disposed in the second housing 211b.

In the second embodiment of the present disclosure, the first housing 211a includes a first sensor housing 2111a and a first cable housing 2112a connected to the rear end of the first sensor housing 2111a. In addition, the second housing 211b includes a second sensor housing 2111b and a second cable housing 2112b connected to the rear end of the second sensor housing 2111b.

In this case, the first cable housing 2112a includes a first cylindrical body 2112a′ disposed to surround the outer circumferential surface of the first cable 213a and a first flange 2112a″ protruding and extending radially outward from the outer circumferential surface of the first cylindrical body 2112a′, and the second cable housing 2112b includes a second cylindrical body 2112b′ disposed to surround the outer circumferential surface of the second cable 213b and a second flange 2112b″ protruding and extending radially outward from the outer circumferential surface of the second cylindrical body 2112b′.

In the second embodiment of the present disclosure, the first housing 211a and the second housing 211b are provided with first fixing protrusions 2113a, 2113b for protruding in the vertical direction on at least one of the upper and lower surfaces, respectively. The first fixing protrusions 2113a, 2113b may are provided with protrusion bodies 2113a′, 2113b′ for protruding from the upper or lower surfaces of the first sensor housing 211a or the second sensor housing 211b at a predetermined height, and hooks 2113a″ and 2113b″ for additionally protruding by being extended in the front and rear directions from an extended end of the protrusion bodies 2113a′ and 2113b′.

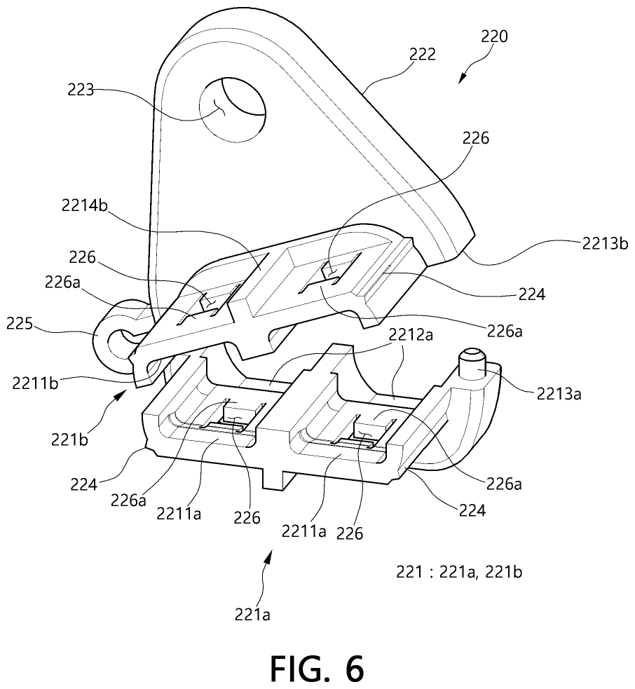

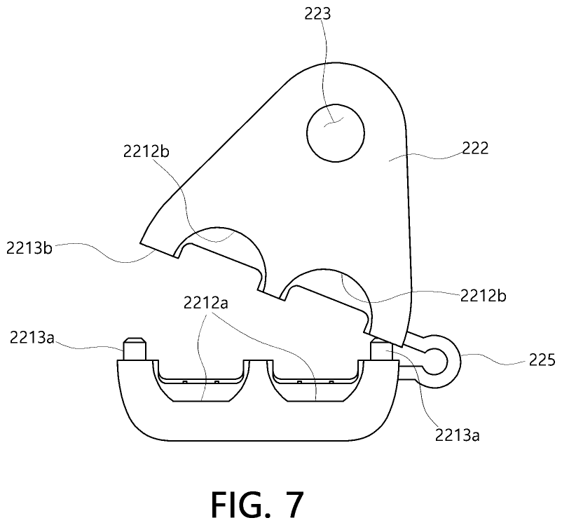

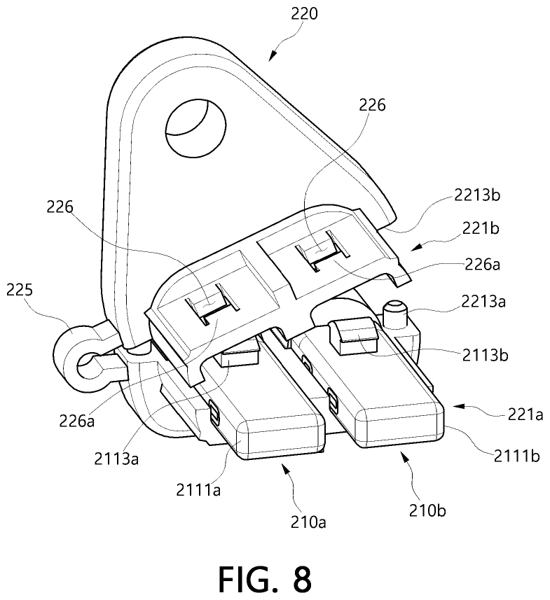

FIG. 6 shows a perspective view of a housing holder of a wheel speed sensing device according to the second embodiment of the present disclosure, and FIG. 7 shows a rear view of the housing holder of the wheel speed sensing device according to the second embodiment of the present disclosure. FIG. 8 shows a diagram showing an unassembled state of the wheel speed sensing device according to the second embodiment of the present disclosure.

Referring to FIGS. 6 to 8, in the second embodiment of the present disclosure, the housing holder 220 may include a retaining portion 221 for surrounding and retaining the outer surface of the first housing 211a and the second housing 211b and an extending portion 222 for protruding and extending upward from the retaining portion 121 such that the retaining member (not shown) for retaining the housing holder onto the chassis is coupled thereto. The extending portion 222 may be provided with a through hole 223 through which the retaining member is disposed.

In the second embodiment of the present disclosure, the retaining portion 221 includes a first retaining member 221a and a second retaining member 221b. The first retaining member 221a is disposed to surround the rear lower portions of the first housing 211a and the second housing 211b. In addition, the second retaining member 221b is disposed to surround the rear upper portions of the first housing 211a and the second housing 211b and is fastened to the first retaining member 221a.

The first retaining member 221a includes a lower sensor housing retaining portion 2211a disposed to surround the rear lower portions of the first sensor housing 2111a and the second sensor housing 2111b, and a lower cable housing retaining portion 2212a disposed to surround the lower portions of the first cable housing 2112a and the second cable housing 2112b.

In this case, the lower sensor housing retaining portion 2211a and the lower cable housing retaining portion 2212a may be provided adjacent to the front and rear sides. In addition, the boundary between the lower sensor housing retaining portion 2211a and the lower cable housing retaining portion 2212a may be formed to be stepped.

The second retaining member 221b includes an upper sensor housing retaining portion 2211b disposed to surround the rear upper portions of the first sensor housing 2111a and the second sensor housing 2111b, and an upper cable housing retaining portion 2212b disposed to surround the upper portions of the first cable housing 2112a and the second cable housing 2112b.

In this case, the upper sensor housing retaining portion 2211b and the upper cable housing retaining portion 2212b may be provided adjacent to the front and rear sides. In addition, the boundary between the upper sensor housing retaining portion 2211b and the upper cable housing retaining portion 2212b may be formed to be stepped.

The steps of the boundary between the lower sensor housing retaining portion 2211b and the lower cable housing retaining portion 2212b and the steps of the boundary between the upper sensor housing retaining portion 2211b and the upper cable housing retaining portion 2212b are formed to catch the first cable housing 2112a and the second cable housing 2112b when the first sensor module 210a and the second sensor module 210b are inserted into the retaining portion 221 to help the first sensor module 210a and the second sensor module 210b are disposed in place.

In the second embodiment of the present disclosure, the housing holder 220 further includes a first fixing through hole 226 vertically penetrated through at least one of the lower sensor housing retaining portion 2211a and the upper sensor housing retaining portion 2211b, so that the first fixing protrusions 2113a, 2113b are inserted thereinto.

At this time, the housing holder 220 may further include an elastic guide 226a for protruding inwardly from the first fixing through hole 226 to the front and rear of the first fixing through hole 226, and elastically deformed upward by hooks 2113a″, 2113b″ when the first fixing protrusions 2113a, 2113b enter, and restored after the first fixing protrusions 2113a, 2113b enter, and disposed so that the lower surfaces of the hooks 2113a″, 2113b″ are caught. When the first retaining member 221a and the second retaining member 221b are fastened through the elastic guide 226a, the first fixing protrusions 2113a, 2113b may be smoothly disposed through the first fixing through hole 226.

In the second embodiment of the present disclosure, the first retaining member 221a may be provided with fastening protrusions 2213a on one side and the other side, and the second retaining member 221b may be provided with fastening grooves 2213b corresponding to the fastening protrusions 2213a on one side and the other side. The coupling of the first fixing member 221a and the second retaining member 221b may be achieved through the couplings of the fastening protrusions 2213a and the fastening grooves 2213b.

Of course, the positions of the fastening protrusions 2213a and the fastening grooves 2213b may be changed from each other. That is, it is also possible that the first retaining member 221a has the fastening grooves, and the second retaining member 221b has the fastening protrusions.

In a second embodiment of the present disclosure, the housing holder 220 may further include a connecting member 225 having one side connected to one side of the first retaining member 221a and the other side connected to one side of the second retaining member 221b to connect the first retaining member 221a and the second retaining member 221b. For example, the connecting member 225 may be a connecting link.

The first retaining member 221a and the second retaining member 221b may be connected with each other without being completely separated from each other, even in an unfastened state through the connecting member 225. Through this, transportability and assembly can be improved.

Meanwhile, in the second embodiment of the present disclosure, the extending portion 222 of the housing holder 220 may protrude and extend from the upper portion of the second retaining member 221b. The extending portion 222 may be provided with a through hole 223 through which the retaining member is disposed.

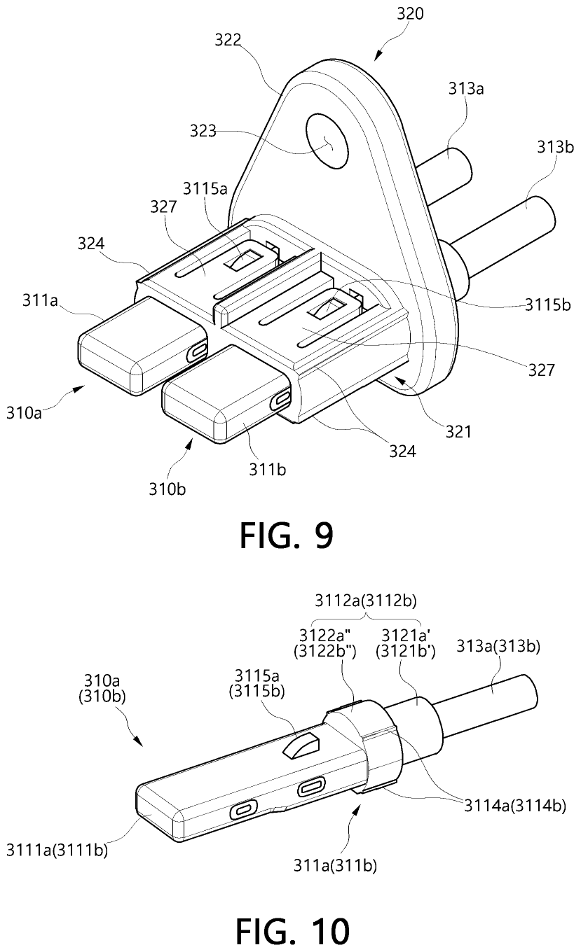

FIG. 9 shows a perspective view of a wheel speed sensing device according to a third embodiment of the present disclosure.

Referring to FIG. 9, the wheel speed sensing device according to the third embodiment of the present disclosure includes a first sensor module 310a, a second sensor module 310b, and a housing holder 320. In the third embodiment of the present disclosure, the housing holder 320 is configured to insert (press-fit) the first sensor module 310a and the second sensor module 310b from the rear to the front, and connects the first housing 311a of the first sensor module 310a and the second housing 311b of the second sensor module 310b.

FIG. 10 shows a perspective view of a sensor module of a wheel speed sensing device according to a third embodiment of the present disclosure.

Referring to FIG. 10, in a third embodiment of the present disclosure, the first sensor module 310a includes a first housing 311a having a first wheel speed sensor disposed therein and a first cable 313a connected to a rear end of the first wheel speed sensor and having a predetermined front section disposed in the first housing 311a. The second sensor module 310b also includes a second housing 311b having a second wheel speed sensor disposed therein and a second cable 313b connected to a rear end of the second wheel speed sensor and having a predetermined front section disposed in the second housing 311b.

In the third embodiment of the present disclosure, the first housing 311a includes a first sensor housing 3111a and a first cable housing 3112a connected to the rear end of the first sensor housing 3111a. In addition, the second housing 311b includes the second sensor housing 3111b and the second cable housing 3112b connected to the rear end of the second sensor housing 3111b.

In this case, the first cable housing 3112a includes a first cylindrical body 3112a′ disposed to surround the outer circumferential surface of the first cable 313a and a first flange 3112a″ for protruding and extending radially outward from the outer circumferential surface of the first cylindrical body 3112a′, and the second cable housing 3112b includes a second cylindrical body 3112b′ disposed to surround the outer circumferential surface of the second cable 313b and a second flange 3112b″ for protruding and extending radially outward from the outer circumferential surface of the second cylindrical body 3112b′.

In the third embodiment of the present disclosure, the first cable housing 3112a and the second cable housing 3112a may include second ribs 3114a and 3114b for protruding from the outer circumferential surfaces of the first flange 3112a″ and the second flange 3112b″ to be crushed and provide fixing forces when inserted into the cable housing retaining portion 3212.

In the third embodiment of the present disclosure, the first sensor housing 3111a and the second sensor housing 3111b are provided with second fixing protrusions 3115a and 3115b for protruding in the vertical direction on at least one of the upper and lower surfaces, respectively. The second fixing protrusions 3115a, 3115b may include a portion for protruding from the front to the rear. This portion facilitates the insertion of the second fixing protrusions 3115a, 3115b.

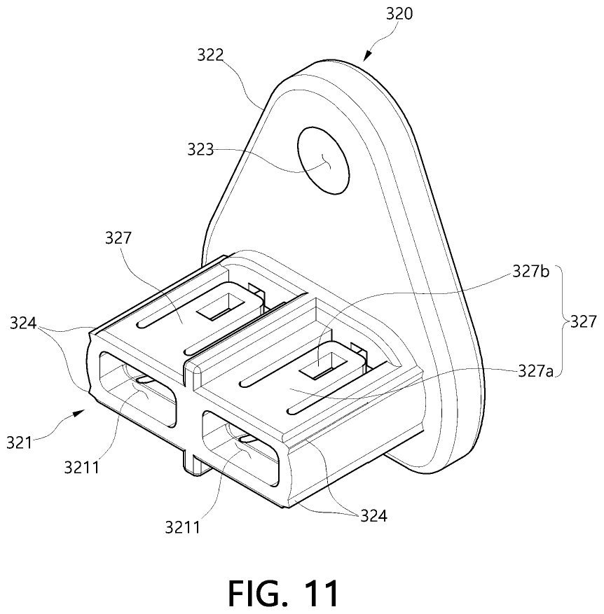

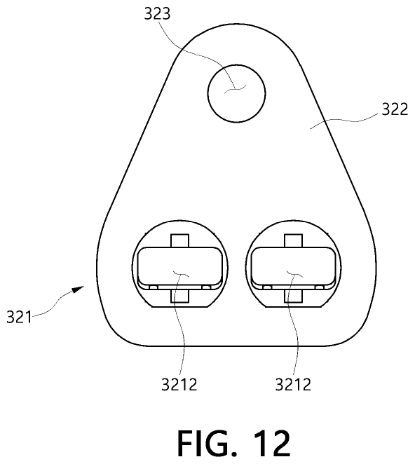

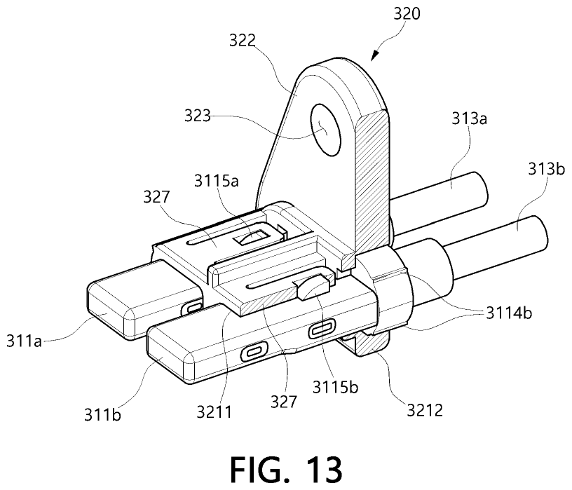

FIG. 11 shows a perspective view of a housing holder of a wheel speed sensing device according to a third embodiment of the present disclosure, and FIG. 12 shows a rear view of the housing holder of the wheel speed sensing device according to the third embodiment of the present disclosure. In addition, FIG. 13 shows a partial cutaway perspective view of the wheel speed sensing device according to the third embodiment of the present disclosure.

Referring to FIGS. 11 to 13, in the third embodiment of the present disclosure, the housing holder 320 may include a retaining portion 321 for surrounding and retaining the outer surface of the first housing 311a and the second housing 311b and an extending portion 322 for protruding and extending upward from the retaining portion 321 such that the retaining member (not shown) for retaining the housing holder onto the chassis is coupled thereto. The extending portion 322 may be provided with a through hole 323 through which the retaining member is disposed.

In the third embodiment of the present disclosure, the retaining portion 321 may include a sensor housing retaining portion 3211 that is formed such that the first sensor module 310a and the second sensor module 310b are inserted from the rear to the front and arranged side by side, and that is disposed to surround the rear portions of the first sensor housing 3111a and the second sensor housing 3111b, and a cable housing retaining portion 3212 disposed to surround the first cable housing 3112a and the second cable housing 3112b.

In this case, the sensor housing retaining portion 3211 and the cable housing retaining portion 3212 may be provided adjacent to the front and rear sides. In addition, the boundary between the sensor housing retaining portion 3211 and the cable housing retaining portion 3212 may be formed to be stepped. The steps may be formed such that when the first sensor module 310a and the second sensor module 310b are inserted into the retaining portion 321, the first cable housing 3112a and the second cable housing 3112b are caught, and the first sensor module 310a and the second sensor module 310b are helped to be disposed in place.

In the third embodiment of the present disclosure, the housing holder 320 includes a snap clip 327 formed side by side on at least one of an upper surface and a lower surface of the sensor housing retaining portion 3211 such that the second retaining protrusions 3115a, 3115b are snap-fitted when the first sensor module 310a and the second sensor module 310b are inserted.

More specifically, the snap clip 327 may include a clip body 327a that when the first sensor module 310a and the second sensor module 310b are inserted into the retaining portion 321, is elastically deformed upward upon entry the second fixing protrusions 3115a, 3115b and restored after entering the second fixing protrusions 3115a, 3115b, and a second fixing through hole 327b formed through the clip body 327a into which the second fixing protrusions 3115a, 3115b are inserted and fixed.

In the third embodiment of the present disclosure, the snap clip 327 allows the first sensor module 310a and the second sensor module 310b to be smoothly inserted when the first sensor module 310a and the second sensor module 310b are inserted into the retaining portion 321 and stably fixed after the insertion.

Although the present disclosure has been described in one embodiment, the spirit of the present disclosure is not limited by the embodiments presented in this specification, and those skilled in the art understanding the spirit of the present disclosure can easily propose other embodiments within the same scope of the spirit of the present disclosure by adding, modifying, deleting, and adding components thereof. However, this is also falling within the scope of the present disclosure.

What is claimed is:

1. A wheel speed sensing device comprising:
a first sensor module including:
a first housing including a first sensor housing and a first cable housing connected to a rear end of the first sensor housing,
a first wheel speed sensor disposed inside the first sensor housing, and
a first cable connected to a rear end of the first wheel speed sensor to transmit a detecting signal of the first wheel speed sensor to an electronic controller, while a predetermined front section thereof is disposed inside the first cable housing;
a second sensor module including:
a second housing including a second sensor housing and a second cable housing connected to a rear end of the second sensor housing,
a second wheel speed sensor disposed inside the second sensor housing, and
a second cable connected to a rear end of the second wheel speed sensor to transmit a detecting signal of the second wheel speed sensor to an electronic controller, while a predetermined front section thereof is disposed inside the second cable housing; and
a housing holder connecting the first housing and the second housing so that the first sensor module and the second sensor module are aligned and arranged side by side;
wherein the housing holder includes:
a retaining portion for surrounding and retaining an outer surface of the first housing and the second housing, and
an extending portion for protruding and extending upward from the retaining portion such that the retaining member for retaining the housing holder onto a chassis is coupled thereto.

2. The wheel speed sensing device of claim 1, wherein the retaining portion includes:
a sensor housing retaining portion disposed to surround rear portions of the first sensor housing and the second sensor housing, and
a cable housing retaining portion disposed to surround the first cable housing and the second cable housing.

3. The wheel speed sensing device of claim 2, wherein the housing holder further includes:
a first rib for protruding from an outer surface of the sensor housing retaining portion to be crushed and provide fixing force when assembled to the chassis.

4. The wheel speed sensing device of claim 2, wherein the first cable housing includes:
a first cylindrical body disposed to surround an outer circumferential surface of the first cable, and
a first flange protruding and extending radially outward from an outer circumferential surface of the first cylindrical body; and
wherein the second cable housing includes:
a second cylindrical body disposed to surround an outer circumferential surface of the second cable, and
a second flange protruding and extending radially outward from an outer circumferential surface of the second cylindrical body.

5. The wheel speed sensing device of claim 1, wherein the retaining portion includes:
a first retaining member disposed to surround rear lower portions of the first housing and the second housing, and
a second retaining member disposed to surround rear upper portions of the first housing and the second housing and fastened to the first retaining member.

6. The wheel speed sensing device of claim 5, wherein the extending portion protrudes and extends from an upper portion of the second retaining member.

7. The wheel speed sensing device of claim 5, wherein the first retaining member includes:
a lower sensor housing retaining portion disposed to surround rear lower portions of the first sensor housing and the second sensor housing, and
a lower cable housing retaining portion disposed to surround lower portions of the first cable housing and the second cable housing; and
wherein the second retaining member includes:
an upper sensor housing retaining portion disposed to surround rear upper portions of the first sensor housing and the second sensor housing, and
an upper cable housing retaining portion disposed to surround the upper portions of the first cable housing and the second cable housing.

8. The wheel speed sensing device of claim 7, wherein the first housing and the second housing include:
first fixing protrusions for protruding in a vertical direction on at least one of the upper and lower surfaces, and
wherein the housing holder further includes:
first fixing through holes vertically penetrated through at least one of the lower sensor housing retaining portion and the upper sensor housing retaining portion, so that the first fixing protrusions are inserted thereinto.

9. The wheel speed sensing device of claim 8, wherein the first fixing protrusions include:
a protrusion body for protruding from upper surface or lower surface of the first sensor housing or the second sensor housing at a predetermined height, and
a hook additionally for protruding by being extended in the front and rear directions from an extended end of the protrusion body.

10. The wheel speed sensing device of claim 9, wherein the housing holder further includes:
an elastic guide for protruding inwardly from the first fixing through hole to a front and rear of the first fixing through holes, and elastically deformed upward by the hook when the first fixing protrusions enter, and restored after the first fixing protrusions enter, and disposed so that a lower surface of the hook is caught.

11. The wheel speed sensing device of claim 5, wherein the first retaining member includes a fastening protrusion or a fastening groove at one side and the other side, and
wherein the second retaining member includes a fastening groove or a fastening protrusion corresponding to the fastening protrusion or the fastening groove at one side and the other side.

12. The wheel speed sensing device of claim 11, wherein the housing holder further include:
a connecting member having one side connected to one side of the first retaining member and the other side connected to one side of the second retaining member to connect the first retaining member and the second retaining member.

13. The wheel speed sensing device of claim 1, wherein the retaining portion includes:
a sensor housing retaining portion formed such that the first sensor module and the second sensor module are inserted from a rear to a front and arranged side by side, and disposed to surround the rear portions of the first sensor housing and the second sensor housing, and
a cable housing retaining portion disposed to surround the first cable housing and the second cable housing.

14. The wheel speed sensing device of claim 13, wherein the first sensor housing and the second sensor housing include:
second fixing protrusions for protruding in the vertical direction on at least one of an upper and lower surfaces, and
wherein the housing holder further includes:
a snap clip formed side by side on at least one of an upper surface and lower surfaces of the sensor housing retaining portion such that the second retaining protrusions are snap-fitted when the first sensor module and the second sensor module are inserted.

15. The wheel speed sensing device of claim 13, wherein the first cable housing includes:
a first cylindrical body disposed to surround an outer circumferential surface of the first cable, and
a first flange for protruding and extending radially outward from an outer circumferential surface of the first cylindrical body; and
wherein, the second cable housing includes:
a second cylindrical body disposed to surround an outer circumferential surface of the second cable, and
a second flange for protruding and extending radially outward from an outer circumferential surface of the second cylindrical body;
wherein the first flange and the second flange are inserted and seated in the cable housing retaining portion.

16. The wheel speed sensing device of claim 15, wherein the first cable housing and the second cable housing include:
a second rib for protruding from an outer circumferential surfaces of the first flange and the second flange to be crushed and provide fixing forces when inserted into the cable housing retaining portion.
